(19) United States
(12) Patent Application Publication
(10) Pub. No.: US 2007/0121189 A1
(43) Pub. Date: May 31, 2007

(54) DATA TRANSMISSION DEVICES FOR COMMUNICATION FACILITIES OF A PASSIVE OPTICAL NETWORK

(75) Inventors: Thierry ZAMI, Massy (FR); Dominique Chiaroni, Antony (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/560,360

(22) Filed: Nov. 16, 2006

(30) Foreign Application Priority Data
Nov. 17, 2005 (FR) 0553489

(51) Int. Cl. G02F 1/03; G02F 1/07

(52) U.S. Cl. 359/246

(57) ABSTRACT

A passive optical network comprises at least one communication facility, termed network head, coupled to at least two communication facilities, termed remote, by transmission and routing means. The network head is charged with transmitting to the remote facilities an alternation of a first portion of an optical carrier, modulated by data to be transmitted according to a chosen bit rate and lasting a first time interval, and of a second portion of this optical carrier, modulated by a clock signal at a base frequency corresponding to the bit rate and lasting a second time interval. Each remote facility is charged, on the one hand, with recovering the base frequency in the first and second received portions, and, on the other hand, with transmitting to the network head, during chosen time slots synchronized by the network head, the part which corresponds to these time slots in some at least of the second portions received successively after having overmodulated with data to be transmitted the clock signal that it contains.

### CROSS-REFERENCE TO RELATED APPLICATIONS

This application is based on French Patent Application No. 0553489 filed on Nov. 17, 2005, the disclosure of which is hereby incorporated by reference thereto in its entirety, and the priority of which is hereby claimed under 35 U.S.C §119.

### BACKGROUND OF THE INVENTION

1. Field of the Invention

The invention relates to Passive Optical Networks (or PONs), and more particularly to the exchange of data traffic between a communication facility termed “network head” (or “hub”) and communication facilities termed “remote” within such PON networks.

2. Description of the Prior Art

Here the expression “passive optical network” is understood to mean an optical network in which no optical/electrical/optical type regeneration is performed between the network head (or hub) and the remote facilities. It might for example be a tree structure optical access network.

Moreover, here the expression “network head” (or hub) is understood to mean a communication facility allowing other communication facilities, which are connected to it, to access another network, such as for example a ring network. It might for example be an OLT (“Optical Line Terminal”) type facility in which is centralized the management of the access rights of the access network to which it is linked as well as possibly the management of the allocation of wavelength(s).

Furthermore, here the expression “remote facility” is understood to mean a communication facility which can access another network only by way of a network head. It might for example be a user terminal, possibly of ONU (“Optical Network Unit”) type.

One of the objectives of communication network operators is to offer ever more significant bit rates to an ever growing number of users, without this engendering overly significant costs. To achieve this objective, it is for example possible to use access networks of PON type, and in particular those which exhibit a high performance/cost ratio. Such in particular is the case for access networks called RCM-PONs (“Remote Color Managed PONs”). This type of network comprises a tree structure relying on the linking up of wavelength-independent remote facilities of RCM-ONU type, with a single OLT type network head, in which the management of the allocation of the wavelengths is centralized.

In certain RCM-PON networks, the network head (OLT) for example transmits to the remote facilities an alternation of a first portion of an optical carrier, modulated by data to be transmitted according to a chosen bit rate and lasting a first time interval, and of a second portion of this same optical carrier, without modulation, and lasting a second time interval. The first portion, termed modulated, is used by the receiving device (or receiver) of each remote facility to recover a clock of the network head, and more precisely the base frequency which corresponds to the chosen bit rate of the transmitted data. The second portion, termed continuous, is used “on line” by each remote facility to transmit data to the network head. More precisely, the remote facility comprises a transmission device (or transmitter) charged with modulating the second carrier portion that it receives with the data to be transmitted lasting time slots which are concomitant with the second time intervals.

When a first time interval finishes, the receiving device (or receiver) of the remote facility is no longer able to recover the base frequency, since the second carrier portion that it receives, during the second time interval which follows the first, does not so allow. Therefore, one is compeled to use, in the remote facilities, receiving devices (or receiver) operating in burst mode, this being expensive.

This type of RCM-PON network is in particular described in the following documents:
D1: N. J. Frigo, P. P. Iannone, P. D. Magill, T. E. Darcie, M. M. Downs, B. N. Desai, U. Koren, T. L. Koch, C. Dragon, H. M. Presby, and G. E. Bodeep, “A Wavelength-Division Multiplexed Passive Optical Network with Cost-Shared Components”, pages 1365-1367, IEEE Photonics Technology Letter, Vol. 6, N^{o} 11, November 1994, and
D2: Fu-Tai An, Kyeong Soo Kim, David Gutierrez, Scott Yam, Eric (Shih-Tse) Hu, Kapil Shrikhande, and Leonid G. Kazovsky, “SUCCESS: A Next-Generation Hybrid WDM/TDM Optical Access Network Architecture”, pages 2557-2569, Journal of Lightwave Technology, Vol. 22, N^{o} 11, November 2004.

Variant embodiments of the RCM-PON network have also been described in the following documents:
D3: D J. Shin, D. K. Jung, H. S. Shin, J. W. Kwon, Seongtaek Hwang, Y. J. Oh, and C. S. Shim, “Hybrid WDM/TDM-PON for 128 subscribers using a-selection-free transmitters”, PostDeadline paper PDP4, OFC'2004, and
D4: N. Deng, N. C. Chan, L. K. Chen F. Tong, “Data re-modulation on downstream OFSK signal for upstream transmission in WDM passive optical network”, Electronics Letters, Vol. 39, N^{o}24, pages 1741-1743, November 2003.

However neither of these two variants is entirely satisfactory. The variant described in document D3 uses Fabry-Perot cavity semiconductor lasers with injection of Amplified Spontaneous Emission (or ASE) which have shorter ranges and fairly low bit rates. The variant described in document D4 implements a phase modulation of the downlink traffic (from the station head to the remote facilities) which requires the use of specific receiving devices in the remote facilities.

The invention is therefore aimed at proposing an alternative solution to those known to the prior art.

### SUMMARY OF THE INVENTION

It proposes for this purpose a passive optical network, comprising at least one communication facility, termed network head, coupled to at least two communication facilities, termed remote, by transmission and routing means, wherein said network head is arranged to transmit to the remote facilities an alternation of a first portion of an optical carrier, modulated by data to be transmitted according to a chosen bit rate and lasting a first time interval, and of a second portion of this optical carrier, modulated by a clock signal (periodic, such as for example a sinusoid) at a base frequency (or tempo) corresponding to the bit rate and lasting a second time interval, and each remote facility is arranged, on the one hand to recover the base frequency in the first and second received portions, and, on the other hand, to transmit to the network head, during chosen time slots synchronized by the network head, the part which corresponds to these time slots in some at least of the second portions received successively after having overmodulated with data to be transmitted the clock signal that it contains.

Here the expression “alternation” is understood to mean the generation of a first portion during a first time interval (of a chosen duration Td) followed by the generation of a second portion during a second time interval (of a chosen duration Tu) disjoint from the first but consecutive with the latter, then again the generation of a new first portion during a new first time interval followed by the generation of a new second portion during a new second time interval, and so on and so forth. Each first or second portion is thus generated periodically, according to a period equal to Td+Tu.

The PON network according to the invention can comprise other characteristics which can be taken separately or in combination, and in particular:
each remote facility is arranged to overmodulate the clock signal with data to be transmitted according to a technique chosen from a group comprising at least a technique termed “Non-Return to Zero” (or NRZ) and a technique termed “Return to Zero” (or RZ);
it can for example be arranged in the form of a network with tree structure comprising K remote facilities each comprising an input/output, and a network head comprising an input/output. In this case its transmission and routing means for example comprise i) a main optical fiber comprising a first end linked to the input/output of the network head and a second end, and dedicated to the transmission of the downlink traffic and of the uplink traffic (from the remote facilities to the network head), ii) an optical coupler comprising at least one input linked to the second end of the main optical fiber and K outputs, and iii) K secondary optical fibers of chosen respective lengths and each comprising a first end linked to one of the K outputs of the optical coupler and a second end linked to the input/output of one of the K remote facilities;
in a first variant, it can for example be arranged in the form of a network with tree structure comprising K remote facilities, each comprising an input and an output, and a network head comprising an input and an output. In this case its transmission and routing means comprise i) a downlink main optical fiber comprising a first end linked to the output of the network head and a second end, ii) a first optical coupler comprising at least one input, linked to the second end of the downlink main optical fiber and at least K outputs, iii) K downlink secondary optical fibers of chosen respective lengths and each comprising a first end linked to one of the K outputs of the first optical coupler and a second end linked to the input of one of the K remote facilities, iv) an uplink main optical fiber comprising a first end linked to the input of the network head and a second end, v) a second optical coupler comprising at least K inputs and at least one output linked to the second end of the uplink main optical fiber, and vi) K uplink secondary optical fibers of chosen respective lengths and each comprising a first end linked to one of the K inputs of the second optical coupler and a second end linked to the output of one of the K remote facilities;
in a second variant, it can be arranged in the form of a network with tree structure comprising a network head, comprising an input linked to a first internal optical demultiplexer of type 1×N and an output fed by the output of a first internal optical multiplexer of type N×1, and N groups of Kn remote facilities, each comprising an input and an output. In this case its transmission and routing means comprise i) a downlink main optical fiber comprising a first end linked to the output of the network head and a second end, ii) a second optical demultiplexer of type 1×N, comprising at least one input, linked to the second end of the downlink main optical fiber and at least N outputs, iii) N first optical couplers comprising at least one input, linked to one of the N outputs of the second optical demultiplexer and at least Kn outputs each linked to the input of one of the Kn remote facilities of one of the N groups, iv) an uplink main optical fiber comprising a first end linked to the input of the network head and a second end, v) a second optical multiplexer of type N×1, comprising at least N inputs and at least one output linked to the second end of the uplink main optical fiber, and vi) N second optical couplers each comprising at least Kn inputs each linked to the output of one of the Kn remote facilities of one of the N groups and at least one output linked to one of the N inputs of the second optical multiplexer.

The invention also proposes a sending/receiving device, for a communication facility, termed remote, suitable for being coupled to a communication facility, termed network head, in a passive optical network.

This sending/receiving device comprises:
a coupler comprising an input and first and second outputs and suitable for receiving from the network head, on its input, alternations of a first portion of an optical carrier, modulated by data according to a chosen bit rate and lasting a first time interval, and of a second portion of this optical carrier, modulated by a clock signal at a base frequency corresponding to the bit rate and lasting a second time interval,
a receiving device coupled to the first output of the coupler and arranged to recover the base frequency in the first and second received portions, and
a transmission device coupled to the second output of the coupler and arranged to transmit to the network head, during chosen time slots synchronized by this network head, the part which corresponds to these time slots in some at least of the second portions received successively by the remote facility, after having overmodulated with data to be transmitted the clock signal that it contains.

The transmission device of this sending/receiving device can be arranged to overmodulate the clock signal with data to be transmitted according to a technique chosen from a group comprising at least a technique termed Non-Return to Zero (NRZ) and a technique termed Return to Zero (RZ).

The invention also proposes a communication facility of the type termed remote, furnished with a sending/receiving device of the type of that presented hereinabove.

The invention is particularly well suited, although in a nonexclusive manner, to RCM-PON type networks.

Other characteristics and advantages of the invention will become apparent on examination of the description detailed hereafter, and of the appended drawings.

### BRIEF DESCRIPTION OF THE DRAWINGS

FIG. 1 illustrates in a very diagrammatic manner a first exemplary embodiment of a passive optical network (PON) comprising a network head and remote facilities according to the invention.

FIG. 2 illustrates in a very diagrammatic manner an exemplary embodiment of a second device for transmitting data equipping a sending/receiving device according to the invention.

FIG. 3 illustrates in a very diagrammatic manner a second exemplary embodiment of a passive optical network (PON) comprising a network head and remote facilities according to the invention.

FIG. 4 illustrates in a very diagrammatic manner a third exemplary embodiment of a passive optical network (PON) comprising a network head and remote facilities according to the invention.

The appended drawings will be able not to only serve to supplement the invention, but also to contribute to the definition thereof, if appropriate.

### DETAILED DESCRIPTION OF THE PREFERRED EMBODIMENT

The invention is aimed at enabling the synchronization of the receiving devices (or receivers) of communication facilities, termed remote, of a passive optical network (PON).

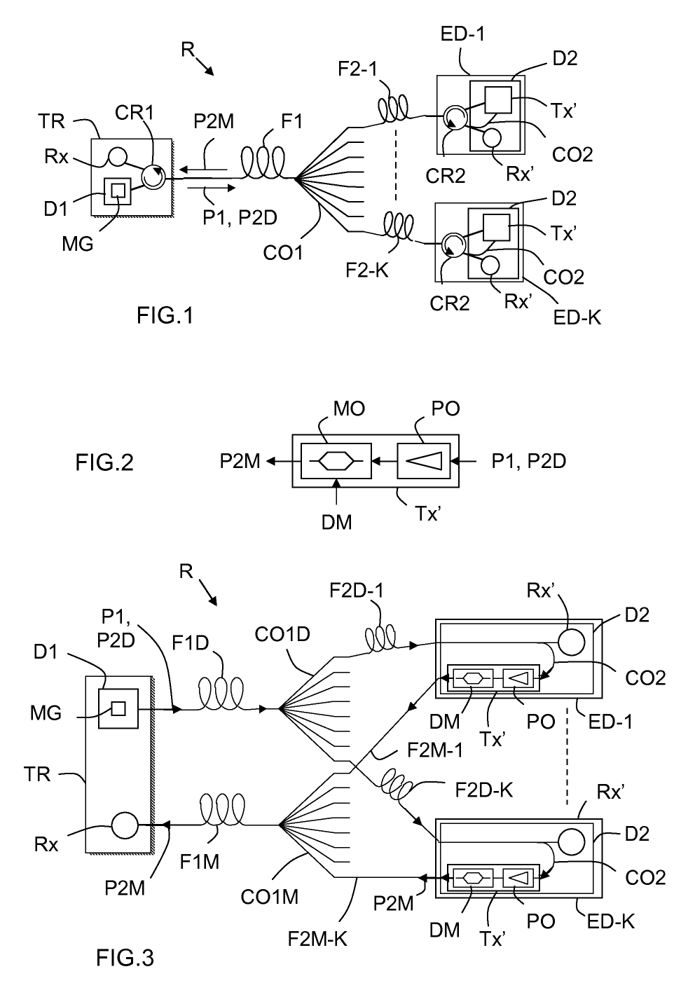

We refer first of all to FIGS. 1 and 2 to present the invention with reference to a first exemplary implementation, which is purely illustrative and therefore nonlimiting.

As is illustrated in FIG. 1, a passive optical network (or PON) R, comprises at least one communication facility TR, that is generally called a “network head” (or hub), and at least two communication facilities ED-k (k=1 to K and K>1), termed remote, coupled to the network head TR by way of transmission and routing means.

In what follows, the network R is considered, by way of nonlimiting example, to be that of RCM-PON (Remote Color Managed PONs) type, the network head TR to be a facility of OLT (Optical Line Terminal) type and the remote facilities to be of ONU (Optical Network Unit) type. But, the invention is not limited to these types of communication facilities and to this particular type of PON network.

The network head TR comprises at least one first device (or module) for transmitting data D1, according to the invention, that hereafter will be called first transmitter, and at least one first device (or module) for receiving data Rx, that hereafter will be called first receiver.

In the nonlimiting example illustrated in FIG. 1, the network head TR comprises an input/output and not an input and an output, as will be seen in a second exemplary embodiment which will be described further on with reference to FIG. 3. This input/output is connected to a circulator CR1, which is also connected to the output of the first transmitter D1 and to the input of the first receiver Rx.

The first transmitter D1 is charged with generating bound for the remote facilities ED-k an alternation of first P1 and second P2D portions of an optical carrier. Here the expression “alternation” is understood to mean the generation of a first portion P1 during a first time interval (of a chosen duration Td) followed by the generation of a second portion P2D during a second time interval (of a chosen duration Tu) disjoint from the first but consecutive with the latter, then again the generation of a new first portion P1 during a new first time interval followed by the generation of a new second portion P2D during a new second time interval, and so on and so forth. Each first P1 or second P2D portion is thus generated periodically, according to a period equal to Td+Tu.

Each first time interval corresponds to a phase during which the network head TR transmits data to the remote facilities ED-k, while each second time interval corresponds to a phase during which the various remote facilities ED-k are permitted to transmit data to the network head TR, one after another, with a possible time overlap, as will be seen further on. Each remote facility ED-k therefore has a fraction (or “slot” or time slot) of each second time interval to transmit data to the network head TR.

The first transmitter D1 comprises a generation module MG charged with generating a carrier, that is to say a laser line, and, on the one hand, with modulating this carrier with data to be transmitted during each first time interval and according to a chosen bit rate (for example 1 Gbits/s), so as to constitute a first portion P1, and on the other hand, with modulating the carrier by a clock signal at a base frequency corresponding to the bit rate (1 GHz in the case of a bit rate of 1 Gbit/s) lasting each second time interval, so as to constitute a second portion P2D.

For example, the generation module MG comprises a laser charged with generating the carrier and a modulator charged with modulating the first P1 and second P2D portions of this carrier.

For example, the clock signal is a sinusoid. But, it might be any type of periodic signal whose frequency corresponds to the base frequency of the modulation of the first portion of carrier P1.

The modulation of the first portion of the carrier P1 can be done by means of the technique termed “Return to Zero” (or RZ) or of the technique termed “Non-Return to Zero” (or NRZ).

The alternations of first P1 and second P2D carrier portions, modulated according to the invention, are communicated by the first transmitter D1 to the circulator CR1, so as to be transmitted to the remote facilities ED-k via the transmission and routing means which will be described further on.

Each remote facility ED-k comprises a sending/receiving device D2 consisting of a second device (or module) for transmitting data Tx′, that hereafter will be called second transmitter, of a second device (or module) for receiving data Rx′, that hereafter will be called second receiver and of a coupler CO2 of type 1×2 (an input and first and second outputs).

In the nonlimiting example illustrated in FIG. 1, each remote facility ED-k comprises an input/output and not an input and an output, as will be seen in a second exemplary embodiment which will be described further on with reference to FIG. 3. This input/output is connected to a circulator CR2, which is also connected to the output of the second transmitter Tx′ and to the input of the second receiver Rx′ of the sending/receiving device D2.

Each second receiver Rx′ is charged with receiving the first portions of carrier P1 so as, on the one hand, to extract the data which modulate them, and on the other hand, to determine the base frequency which corresponds to the bit rate of these data and which makes it possible to set it as well as its remote facility ED-k to a clock of the network head TR. This setting is useful, inter alia, in the determination of the initial instant at which the second transmitter Tx′ of a remote facility ED-k is permitted to transmit data destined for the network head TR and the final instant at which this second transmitter Tx′ is no longer permitted to transmit data. These initial and final instants therefore very precisely define the setting of the transmission time slot of a given remote facility ED-k with respect to the clock of the network head TR.

Each second receiver Rx′ also receives the second portions of carrier P2D so as to continue to determine the base frequency defined by the clock signal which modulates the carrier. Thus, the second receiver Rx′ has available without interruption the base frequency, whether in a first or a second time interval, thereby allowing it to set itself permanently to a clock of the network head TR.

This is particularly advantageous since this makes it possible to use in the remote facilities ED-k conventional second receivers Rx′ and not ones that operate in burst mode whose cost is appreciably more significant and whose performance in terms of reception sensitivity is somewhat less good.

The second transmitter Tx′ also receives a chosen fraction of the first P1 and second P2D carrier portions by virtue of the optical coupler CO2 of type 1×2, coupled to the output of the circulator CR2 which feeds the second receiver Rx′. It is synchronized with respect to a clock of the network head TR by virtue of the base frequency which is permanently determined by the second receiver Rx′ of its remote facility ED-k.

The second transmitter Tx′ is charged with overmodulating with data, to be transmitted to the network head TR, the clock signal which modulates the carrier of some at least of the second portions P2D that it receives. All the second portions of carrier P2D are not compulsorily overmodulated, given that a remote facility ED-k does not necessarily have data to be transmitted to the network head TR in the time slot allocated to it in each second interval.

As is illustrated in FIG. 2, the second transmitter Tx′ of each sending/receiving device D2 can for example comprise an optical gate PO and an optical modulator MO.

The optical gate PO comprises an input coupled to one of the two outputs of the optical coupler CO2 and an output coupled to the input of the optical modulator MO. This optical gate PO is charged with allowing through to the optical modulator MO each second carrier portion P2D only during the time slots during which its remote facility ED-k is permitted to transmit uplink traffic towards the network head TR. It might for example be an optical gate operating in burst mode, such as an SOA (“Semiconductor Optical Amplifier”), but this is not compulsory. It is indeed possible to use any type of fast optical gate, such as for example a lithium niobate switch.

The optical modulator MO receives the data DM which must be transmitted in the uplink traffic, as well as each fraction of second carrier portion P2D, so as to overmodulate with these data DM the clock signal which modulates it.

This overmodulation of the clock signal can be done by means of the technique termed “Return to Zero” (or RZ). But, it is preferable that it be done by means of the technique termed “Non-Return to Zero” (or NRZ). Specifically, when a (periodic) clock signal is modulated with the NRZ technique, a resulting signal is automatically obtained in the RZ format. This is advantageous, since this avoids the need to supplement the optical modulator MO with another facility to obtain such an RZ modulation format.

The optical modulator MO therefore delivers second uplink portions of carrier P2M on its output. In the example illustrated in FIG. 1, these feed the circulator CR2, so as to be transmitted to the network head TR by their remote facility ED-k, via the transmission and routing means. It is the first receiver Rx of the network head TR which is thereafter charged with extracting from each second uplink carrier portion P2M that it receives the data DM that it contains.

We shall now describe three examples of transmission and routing means making it possible to couple a network head TR to remote facilities ED-k.

The example illustrated in FIG. 1 corresponds to a PON network R with tree structure, in which the uplink and downlink traffic follow the same media (bidirectional).

For this purpose, the transmission and routing means comprise:
an optical fiber F1, termed main, comprising a first end linked to the input/output of the network head TR (and therefore to its circulator CR1) and a second end. This main optical fiber F1 ensures the bidirectional transmission of all the uplink and downlink traffic,
an optical coupler CO1 comprising at least one input/output linked to the second end of the main optical fiber F1 and K outputs/inputs. This optical coupler CO1 is charged, on the one hand, with delivering on its K outputs/inputs K identical fractions of the downlink traffic that it receives on its input/output, and on the other hand, delivering on its input/output a time multiplex consisting of the second carrier portions received on its K outputs/inputs, and
K optical fibers F2-k (F2-1 to F2-K), termed secondary, of chosen respective lengths and each comprising a first end linked to one of the K outputs/inputs of the optical coupler CO1 and a second end linked to the input/output of one of the K remote facilities ED-k (ED-1 to ED-K), and therefore to its circulator CR2. These secondary optical fibers F2-k ensure the bidirectional transmission of the uplink and downlink traffic relating to the remote facilities ED-k to which they are respectively coupled.

The respective lengths Lk of the K optical fibers F2-k are for example chosen so that each second carrier portion returns to the network head RT with a delay proportional to the number of remote facilities ED-k which have used it to transmit their data DM. Consequently, the delay δt between two second uplink portions of carrier P2M originating from two successive remote facilities ED-k and ED-k+1 is constant.

In order to maximize the distribution of the capacities between the various remote facilities ED-k, the global period during which the remote facilities ED-k can transmit their data DM can be equal to the period (Td+Tu) between two first successive time intervals during which the network head TR can transmit its data in first portions of carrier P1. In this case, the delay δt between two second uplink portions of carrier P2M is equal to (Td+Tu)/K. It may then happen that at least two slots (transmission time slots) of remote facilities ED-k are partially overlaid, thereby signifying that the network head TR can receive data originating from these remote facilities ED-k. It is this characteristic which allows a distribution of the capacity between the various remote facilities ED-k.

Of course, other distributions of lengths Lk can be envisaged.

Moreover, it will be noted that the durations of the slots (or transmission time slots) allocated to the various remote facilities ED-k might not be equal. They can indeed vary as a function of their requirements in terms of passband. Furthermore, a part of a second portion which is not used by a remote facility ED-k during a given slot can be used by another remote facility, for example ED-k−1 or ED-k+1, as an adjunt to its own slot, if the network head so permits.

This can make it possible to take account of the traffic profiles of the various users, and for example to adapt the capacities of each remote facility as a function of the time of day.

The example illustrated in FIG. 3 corresponds to a network R, of PON type, which is also of tree structure and in which the uplink and downlink traffic follow different media (unidirectional).

This second exemplary embodiment is intended to alleviate a drawback that may be exhibited by a network of the type of that presented hereinabove with reference to FIG. 1. Specifically, in this type of network the uplink P2M and downlink P1 and P2D carriers exhibit the same wavelength and follow the same media, and this may engender a back-scattering effect apt to disturb the transmissions.

To alleviate this potential drawback, the transmission and routing means comprise here:
an optical fiber F1D, termed downlink main, comprising a first end linked to the output of the network head TR (and more precisely to the output of its first transmitter D1) and a second end. This downlink main optical fiber F1D ensures the unidirectional transmission of the downlink traffic,
a first optical coupler CO1D of type 1×K, comprising at least one input linked to the second end of the downlink main optical fiber F1D and at least K outputs. This optical coupler CO1D is charged with delivering on its K outputs K identical fractions of the downlink traffic that it receives on its input,
K optical fibers F2D-k (k=1 to K-F2D-1 to F2D-K), termed downlink secondary, of chosen respective lengths (possibly different) and each comprising a first end linked to one of the K outputs of the first optical coupler CO1D and a second end linked to the input of one of the K remote facilities ED-k (ED-1 to ED-K), and therefore to its second receiver Rx′ and its second transmitter Tx′ via the optical coupler CO2. These downlink secondary optical fibers F2D-k ensure the unidirectional transmission of the downlink traffic intended for the remote facilities ED-k to which they are respectively coupled,
an optical fiber F1M, termed uplink main, comprising a first end linked to the input of the network head TR (and more precisely to its first receiver Rx) and a second end. This uplink main optical fiber F1M ensures the unidirectional transmission of all the uplink traffic,
a second optical coupler CO1M of type Kx1, comprising at least K inputs and at least one output linked to the second end of the uplink main optical fiber F1M. This optical coupler CO1M is charged with delivering on its output a time multiplex consisting of the second carrier portions received on its K inputs, and
K optical fibers F2M-k (k=1 to K-F2M-1 to F2M-K), termed uplink secondary, of chosen respective lengths (possibly different) and each comprising a first end linked to one of the K inputs of the second optical coupler CO1M and a second end linked to the output of one of the K remote facilities ED-k. These uplink secondary optical fibers F2M-k ensure the unidirectional transmission of the uplink traffic originating from the remote facilities ED-k to which they are respectively coupled.

The various lengths Lk of the downlink secondary optical fibers F2D-k and/or of the uplink secondary optical fibers F2M-k are chosen in the same way as in the first example previously described with reference to FIG. 1.

Moreover, in this second exemplary embodiment the uplink and downlink pathways being separate, each remote facility ED-k comprises, on the one hand, an input coupled to the downlink pathway and to the second receiver Rx′ and second transmitter Tx′, by way of an optical coupler CO2 of type 1×2, and on the other hand, an output coupled to the output of the second transmitter Tx′. Except for this difference in arrangement, the operation of the second transmitter Tx′ is identical to that previously described with reference to FIGS. 1 and 3.

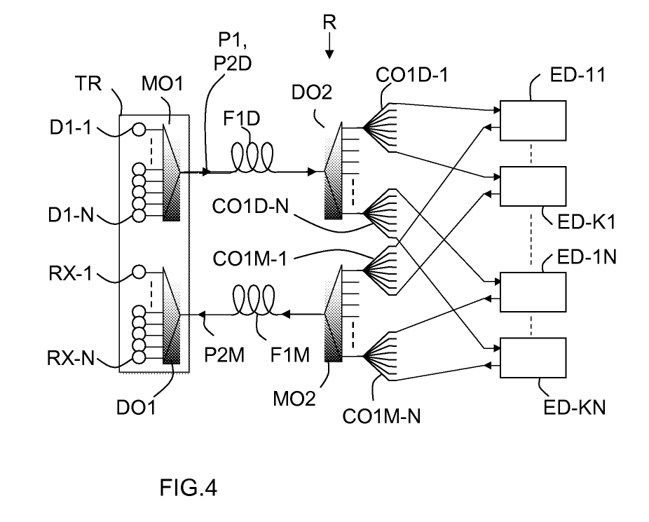

The example illustrated in FIG. 4 corresponds to a network R, of PON type, also of tree structure. Here, the uplink and downlink traffic follow different (unidirectional) media, by way of illustrative and nonlimiting example.

This third exemplary embodiment is intended to allow the use by the network head TR of several N wavelengths associated respectively with N groups Gn of Kn different remote facilities, within the framework of a WDM (“Wavelength Division Multiplexing”) type multiplexing. More precisely, this third example makes it possible to increase the number of remote stations connected to one and the same network head when the fiber resource becomes scarce, and therefore expensive (this may for example be the case when an already installed fiber infrastructure is the basis).

For this purpose, the network head TR comprises N first transmitters D1-n (D1-1 to D1-N), with n=1 to N and N>1, of the type of that previously presented, with reference to FIG. 1, and N first receivers Rx-n (Rx-1 to Rx-N). Each first transmitter D1-n is dedicated to a carrier of a given wavelength.

The outputs of the N first transmitters D1-n are connected respectively to the N inputs of a first optical multiplexer MO1, of type N×1 and whose output is intended to deliver multiplexes of different-wavelength channels consisting of the first and second carrier portions generated by the first N transmitters D1-n. Each first receiver Rx-n is dedicated to a carrier of a given wavelength. The inputs of the N receivers Rx-n are connected respectively to the N outputs of a first optical demultiplexer DO1, of type 1×N and whose input receives multiplexes consisting of the second carrier portions overmodulated by the seconds transmitters Tx′ of the N groups Gn of Kn remote facilities.

The transmission and routing means comprise here:
an optical fiber F1D, termed downlink main, comprising a first end linked to the output of the network head TR (and more precisely to the output of its first optical multiplexer MO1) and a second end. This downlink main optical fiber F1D ensures the unidirectional transmission of the multiplexed downlink traffic,
a second optical demultiplexer DO2 of type 1×N, comprising at least one input linked to the second end of the downlink main optical fiber F1D and at least N outputs. This second optical demultiplexer DO2 is charged with respectively delivering on its N outputs the N first and second carrier portions of N different wavelengths that it receives on its input in multiplexed form,
N first optical couplers CO1D-n (CO1D-1 to CO1D-N) of type 1×Kn, each comprising at least one input linked to one of the N outputs of the second optical demultiplexer DO2 and at least Kn outputs. Each optical coupler CO1D-n is charged with delivering on its Kn outputs Kn identical fractions of the downlink traffic that it receives on its input and which corresponds to a carrier of given wavelength,
N groups of Kn optical fibers, termed downlink secondary, of chosen respective lengths (possibly different) and each comprising a first end linked to one of the Kn outputs of the first optical coupler CO1D-n of the corresponding group Gn and a second end linked to the input of one of the Kn remote facilities ED-kn (k=1 to Kn and n=1 to N-ED-11 to ED-KN) of one of the N different groups Gn, and therefore to its second receiver Rx′ and its second transmitter Tx′ via the optical coupler CO2. These downlink secondary optical fibers ensure the unidirectional transmission of the downlink traffic intended for the remote facilities ED-kn to which they are respectively coupled,
an optical fiber F1M, termed uplink main, comprising a first end linked to the input of the network head TR (and more precisely to its first demultiplexer DO1) and a second end. This uplink main optical fiber F1M ensures the unidirectional transmission of all the multiplexed uplink traffic,
a second optical multiplexer MO2 of type N×1, comprising at least N inputs and at least one output linked to the second end of the uplink main optical fiber F1M. This second optical multiplexer MO2 is charged with delivering in multiplexed form on its output the N time multiplexes of Kn second overmodulated carrier portions of N different wavelengths that it receives on its N inputs,
N second optical couplers CO1M-n (CO1M-1 to CO1M-N) of type Kn×1, each associated with one of the N groups Gn and each comprising at least Kn inputs and at least one output linked to one of the N inputs of the second optical multiplexer MO2. Each optical coupler CO1M-n, associated with a group Gn, is charged with delivering on its output a time multiplex consisting of the second carrier portions received on its Kn inputs originating from the Kn remote elements of its group Gn, and
N groups of Kn optical fibers, termed uplink secondary, of chosen respective lengths (possibly different) and each comprising a first end linked to one of the Kn inputs of the second optical coupler CO1M-n of the corresponding group Gn and a second end linked to the output of one of the Kn remote facilities ED-kn (k=1 to Kn and n=1 to N-ED-11 to ED-KN) of the group Gn, and therefore to its second transmitter Tx′. These uplink secondary optical fibers ensure the unidirectional transmission of the uplink traffic originating from the remote facilities ED-kn to which they are respectively coupled.

The invention is not limited to the embodiments of sending/receiving device, of communication facility termed remote, and of passive optical network that are described hereinabove, only by way of example, but it encompasses all the variants that may be envisaged by the person skilled in the art within the scope of the claims hereafter.

There is claimed:

1. A passive optical network comprising at least one communication facility, termed network head, coupled to at least two communication facilities, termed remote, by transmission and routing means, wherein said network head is arranged to transmit to the remote facilities an alternation of a first portion of an optical carrier, modulated by data to be transmitted according to a chosen bit rate and during a first time interval, and of a second portion of said optical carrier, modulated by a clock signal at a base frequency corresponding to said bit rate and during a second time interval, and each remote facility is arranged, on the one hand, to recover said base frequency in the first and second received portions, and, on the other hand, to transmit to said network head, during chosen time slots synchronized by the network head, the part which corresponds to said time slots in at least some of the second portions received successively after having overmodulated with data to be transmitted the clock signal that it contains.

2. The network as claimed in claim 1, wherein said remote facility is arranged to overmodulate said clock signal with data to be transmitted according to a technique chosen from a group comprising at least a technique termed “Non-Return to Zero” (NRZ) and a technique termed “Return to Zero” (RZ).

3. The network as claimed in claim 2, wherein said remote facility is arranged to overmodulate said clock signal with data to be transmitted according to said technique termed Non-Return to Zero (NRZ).

4. The network as claimed in claim 1, wherein said clock signal is a sinusoid.

5. The network as claimed in claim 1, wherein said network is arranged in the form of a network with tree structure comprising K remote facilities and a network head each comprising at least one input/output, and said means of transmission and of routing comprise i) a main optical fiber comprising a first end linked to the input/output of said network head and a second end, ii) an optical coupler comprising at least one input, linked to the second end of the main optical fiber and at least K outputs, and iii) K secondary optical fibers of chosen respective lengths and each comprising a first end linked to one of the K outputs of said optical coupler and a second end linked to the input/output of one of the K remote facilities.

6. The network as claimed in claim 1, wherein said network is arranged in the form of a network with tree structure comprising K remote facilities and a network head each comprising an input and an output, and said means of transmission and of routing comprise i) a downlink main optical fiber comprising a first end linked to the output of the network head and a second end, ii) a first optical coupler comprising at least one input linked to the second end of the downlink main optical fiber and at least K outputs, iii) K downlink secondary optical fibers of chosen respective lengths and each comprising a first end linked to one of the K outputs of said first optical coupler and a second end linked to the input of one of the K remote facilities, iv) an uplink main optical fiber comprising a first end linked to the input of the network head and a second end, v) a second optical coupler comprising at least K inputs and at least one output linked to the second end of the uplink main optical fiber, and vi) K uplink secondary optical fibers of chosen respective lengths and each comprising a first end linked to one of the K inputs of said second optical coupler and a second end linked to the output of one of the K remote facilities.

7. The network as claimed in claim 1, wherein said network is arranged in the form of a network with tree structure comprising a network head, comprising an input linked to a first internal optical demultiplexer of type 1×N and an output fed by the output of a first internal optical multiplexer of type N×1, and N groups of Kn remote facilities, each comprising an input and an output, and said means of transmission and of routing comprise i) a downlink main optical fiber comprising a first end linked to the output of the network head and a second end, ii) a second optical demultiplexer of type 1×N, comprising at least one input, linked to the second end of the downlink main optical fiber and at least N outputs, iii) N_first optical couplers comprising at least one input, linked to one of the N outputs of said second optical demultiplexer and at least Kn outputs each linked to the input of one of the Kn remote facilities of one of the N groups, iv) an uplink main optical fiber comprising a first end linked to the input of the network head and a second end, v) a second optical multiplexer of type N×1, comprising at least N inputs and at least one output linked to the second end of the uplink main optical fiber, and vi) N second optical couplers comprising at least Kn inputs each linked to the output of one of the Kn remote facilities of one of the N groups and at least one output linked to one of the N inputs of said second optical multiplexer.

8. A sending/receiving device, for a communication facility, termed remote, suitable for being coupled to a communication facility, termed network head, said remote facility and said network head forming part of a passive optical network, wherein it comprises i) a coupler comprising an input and first and second outputs and suitable for receiving from said network head, on its input, alternations of a first portion of an optical carrier, modulated by data according to a chosen bit rate and during a first time interval, and of a second portion of said optical carrier, modulated by a clock signal at a base frequency corresponding to said bit rate and during a second time interval, ii) a receiving device coupled to the first output of said coupler and arranged to recover said base frequency in the first and second received portions, and iii) a transmission device coupled to the second output of said coupler and arranged to transmit to said network head, during chosen time slots synchronized by this network head, the part which corresponds to said time slots in at least some of the second portions received successively by said remote facility, after having overmodulated with data to be transmitted the clock signal that it contains.

9. The device as claimed in claim 8, wherein said transmission device is arranged to overmodulate said clock signal with data to be transmitted according to a technique chosen from a group comprising at least a technique termed “Non-Return to Zero” (NRZ) and a technique termed “Return to Zero” (RZ).

10. The device as claimed in claim 9, wherein said transmission device is arranged to overmodulate said clock signal with data to be transmitted according to said technique termed Non-Return to Zero (NRZ).

11. A remote communication facility, for a passive optical network, wherein it comprises a sending/receiving device as claimed in claim 8.
